(19) United States
(12) Patent Application Publication
(10) Pub. No.: US 2026/0200674 A1
(43) Pub. Date: Jul. 16, 2026

(54) A CONTAINER TRANSPORT VEHICLE, AN AUTOMATED STORAGE AND RETRIEVAL SYSTEM AND A METHOD THEREOF

(71) Applicant: AutoStore Technology AS, Nedre Vats (NO)

(72) Inventors: Trond Austrheim, Etne (NO); Ivar Fjeldheim, Haugesund (NO)

(21) Appl. No.: 19/137,028

(22) PCT Filed: Nov. 13, 2023
(86) PCT No.: PCT/EP2023/081569

§ 371 Date: Jun. 9, 2025

(30) Foreign Application Priority Data
Dec. 16, 2022 (NO) 20221355

(51) Int. Cl. B65G 1/04

(52) U.S. Cl. CPC B65G 1/0492; B65G 1/0464

(57) ABSTRACT

The invention concerns a container transport vehicle for handling and transport of storage containers, as well as an automated storage and retrieval system and a method using such a container transport vehicle. The container transport vehicle comprises one or more drive modules configured to move the container transport vehicle along a rail system, a container carrier configured to support the containers and a container handler configured to raise at least one of the storage containers from a position below the rail system.

### TECHNICAL FIELD

The present invention relates to a container transport vehicle, an automated storage and retrieval system using such a container transport vehicle and a method for transport of storage containers using the container transport vehicle.

### BACKGROUND AND PRIOR ART

FIG. 1 discloses a prior art automated storage and retrieval system 1 with a framework structure 100 and FIGS. 2, 3 and 4 disclose three different prior art container handling devices 200,300,400 suitable for operating on such a system 1.

The framework structure 100 comprises upright members 102 and a storage volume comprising storage columns 105 arranged in rows between the upright members 102. In these storage columns 105 storage containers 106, also known as containers, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 200,300,400 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 200,300,400 in a first direction X across the top of the frame structure 100, and a second set of parallel rails 111 arranged perpendicular to the first set of rails 110 to guide movement of the container handling vehicles 200,300,400 in a second direction Y which is perpendicular to the first direction X. Containers 106 stored in the columns 105 are accessed by the container handling vehicles 200,300,400 through access openings 112 in the rail system 108. The container handling vehicles 200,300,400 can move laterally above the storage columns 105, i.e. in a plane which is parallel to the horizontal X-Y plane.

The upright members 102 of the framework structure 100 may be used to guide the containers 106 during raising of the containers 106 out from and lowering of the containers 106 into the columns 105. The stacks 107 of containers 106 are typically self-supporting.

Each prior art container handling device 200,300,400 comprises a handling device body/vehicle body 201,301,401 and first and second sets of wheels 202a,202b,302a,302b,402a,402b which enable the lateral movement of the container handling devices 200,300,400 in the X direction and in the Y direction, respectively. In FIGS. 2, 3 and 4 two wheels in each set are fully visible. The first set of wheels 202a,302a,402a is arranged to engage with two adjacent rails of the first set 110 of rails, and the second set of wheels 202b,302b,402b is arranged to engage with two adjacent rails of the second set 111 of rails. At least one of the sets of wheels 202a, 202b,302a,302b,402a,402b can be lifted and lowered, so that the first set of wheels 202a,302a,402a and/or the second set of wheels 202b,302b,402b can be engaged with the respective set of rails 110, 111 at any one time.

Each prior art container handling device 200,300,400 also comprises a lifting device 303,403 for vertical transportation of containers 106, e.g. raising a container 106 from, and lowering a container 106 into, a storage column 105. The lifting device 303,403 comprises one or more gripping/engaging devices 404 which are adapted to engage a container 106, and which gripping/engaging devices 404 can be lowered from the vehicle 200,300,400 so that the position of the gripping/engaging devices 404 with respect to the vehicle 200,300,400 can be adjusted in a third direction Z which is orthogonal the first direction X and the second direction Y. The gripping device 404 of the container handling device/vehicle 400 in form of a plurality of claws is shown in FIG. 4. The lifting device of the container handling device 200 is located within the vehicle body 201 and is thus not shown.

Conventionally, and also for the purpose of this application, Z=1 identifies the uppermost layer available for containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of containers. Similarly, X=1 . . . n and Y=1 . . . n identifies the position of each storage column 105 in the horizontal plane. Consequently, as an example, and using the Cartesian coordinate system X, Y, Z indicated in FIG. 1, the containers identified as 106′ in FIG. 1 can be said to occupy storage position X=17, Y=1, Z=6. The container handling devices 200,300,400 can be said to travel in layer Z=0, and each storage column 105 can be identified by its X and Y coordinates. Thus, the containers shown in FIG. 1 extending above the rail system 108 are also said to be arranged in layer Z=0.

The storage volume 104 of the framework structure 100 has often been referred to as a storage grid, where the possible storage positions within this grid are referred to as storage cells. Each storage column may be identified by a position in an X- and Y-direction, while each storage cell may be identified by a container number in the X-, Y- and Z-direction.

Each prior art container handling device 200,300,400 comprises a storage compartment or space for receiving and stowing a container 106 when transporting the container 106 across the rail system 108. The storage space may comprise a cavity arranged internally within the vehicle body 201,301,401 as present in FIGS. 2 and 4 and as described in e.g. WO2015/193278A1 and WO2019/206487A1, the contents of which are incorporated herein by reference.

FIG. 3 shows an alternative configuration of a container handling device/vehicle 300 with a cantilever construction. Such a vehicle is described in detail in e.g. NO317366, the contents of which are also incorporated herein by reference.

The central cavity type vehicle 200 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling devices/vehicle 400 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where containers 106 are stored in stacks 107. However, some columns may have other purposes. In FIG. 1, columns 119 and 120 are such special-purpose columns used by the container handling devices 200,300,400 to drop off and/or pick up containers 106 so that they can be transported to an access station (not shown) where the containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the containers 106 may be placed in a random or dedicated column 105 within the framework structure 100, then picked up by any container handling device and transported to a port column 119,120 for further transportation to an access station. The transportation from the port to the access station may require movement along various different directions, by means such as delivery vehicles, trolleys or other transportation lines. Note that the term ‘tilted’ means transportation of containers 106 having a general transportation orientation somewhere between horizontal and vertical.

In FIG. 1, the first port column 119 may for example be a drop-off port column where the container handling devices 200,300,400 can drop off containers 106 to be transported to an access or a transfer station, and the second port column 120 may be a dedicated pick-up port column where the container handling devices 200,300,400 can pick up containers 106 that have been transported from an access or a transfer station.

The access station may typically be a picking or a stocking station where product items are removed from or positioned into the containers 106. In a picking or a stocking station, the containers 106 are normally not removed from the automated storage and retrieval system 1, but are returned into the framework structure 100 again once accessed. A port can also be used for transferring containers to another storage facility (e.g. to another framework structure or to another automated storage and retrieval system), to a transport vehicle (e.g. a train or a lorry), or to a production facility.

A conveyor system comprising conveyors is normally employed to transport the containers between the port columns 119,120 and the access station.

If the port columns 119,120 and the access station are located at different levels, the conveyor system may comprise a lift device with a vertical component for transporting the containers 106 vertically between the port column 119,120 and the access station.

The conveyor system may be arranged to transfer containers 106 between different framework structures, e.g. as is described in WO2014/075937A1, the contents of which are incorporated herein by reference.

When a container 106 stored in one of the storage columns 105 disclosed in FIG. 1 is to be accessed, one of the container handling devices 200,300,400 is instructed to retrieve the target container 106 from its position and transport it to the drop-off port column 119. This operation involves moving the container handling device 200,300,400 to a location above the storage column 105 in which the target container 106 is positioned, retrieving the container 106 from the storage column 105 using the container handling device's 200,300,400 lifting device, and transporting the container 106 to the drop-off port column 119. If the target container 106 is located deep within a stack 107, i.e. with one or a plurality of other containers 106 positioned above the target container 106, the operation also involves temporarily moving the above-positioned containers prior to lifting the target container 106 from the storage column 105. This step, which is sometimes referred to as “digging” within the art, may be performed with the same container handling device that is subsequently used for transporting the target container to the drop-off port column 119, or with one or a plurality of other cooperating container handling devices. Alternatively, or in addition, the automated storage and retrieval system 1 may have container handling devices 200,300,400 specifically dedicated to the task of temporarily removing containers 106 from a storage column 105. Once the target container 106 has been removed from the storage column 105, the temporarily removed containers 106 can be repositioned into the original storage column 105. However, the removed containers 106 may alternatively be relocated to other storage columns 105.

When a container 106 is to be stored in one of the columns 105, one of the container handling devices 200,300,400 is instructed to pick up the container 106 from the pick-up port column 120 and transport it to a location above the storage column 105 where it is to be stored. After any containers 106 positioned at or above the target position within the stack 107 have been removed, the container handling device 200,300,400 positions the container 106 at the desired position. The removed containers 106 may then be lowered back into the storage column 105, or relocated to other storage columns 105.

For monitoring and controlling the automated storage and retrieval system 1, e.g. monitoring and controlling the location of respective containers 106 within the framework structure 100, the content of each container 106; and the movement of the container handling devices 200,300,400 so that a desired container 106 can be delivered to the desired location at the desired time without the container handling devices 200,300,400 colliding with each other, the automated storage and retrieval system 1 comprises a control system 109 which typically is computerized and which typically comprises a database for keeping track of the containers 106.

WO2019/086237 discloses an automated storage and retrieval system comprising a rail system forming a grid pattern in the horizontal plane comprising a plurality of grid cells, each comprising a grid opening, and stacks of storage containers arranged in storage columns located beneath the rail system. Each storage column is located vertically below the grid opening. The system further comprises a multi trolley vehicle for transporting storage containers between the storage columns and a deployment area. The multi trolley vehicle comprises a trolley assembly comprising a plurality of trolleys coupled to each other, where each trolley provides at least one container volume for storing at least one of the storage containers and where each trolley comprises moving devices allowing movement of the trolley assembly.

Automated storage and retrieval systems as described above are typically constructed to be operated in areas at ambient temperatures, e.g. about 20° C. However, for some type of products optimal storage temperature may be different. For example, it may be desirable to store food at fridge temperature, typically between 1-4° C., or at freezer temperature, typically below −18° C. or below −20° C.

Furthermore, there may be situations to surround an automated storage and retrieval system with an atmosphere different from the ambient atmosphere, for example to reduce the risk of fire ignition by reducing the oxygen concentration in the surrounding atmosphere.

Automatic storage and retrieval systems having different temperature zones, and where the temperature can be controlled, are known. For example, patent publication WO2015/124610A1 describes a system for receiving and storing processed refrigerated and frozen food products using a plurality of container handling vehicles operated on a rail system. In this prior art solution, the containers are stacked below a common rail system in two different storage volumes separated by a wall. The container handling vehicles are allowed to move freely above the two storage volumes at a higher operating temperature such as room-temperature.

The above prior art system has some drawbacks.

One drawback is that each of the container handling devices 200,300,400 may handle only one container 106 at the time, thereby reducing storage system's container handling efficiency. This drawback may be particularly important for very large storage systems 1 such as framework structures 100 which are more than 100 storage columns in the first direction, more than 100 storage columns in the second direction and a depth of more than 8 stacked containers.

Another drawback which is particularly relevant for systems 1 of large depths (for example depths of more than 8 stacked containers) is related to the described digging operation where the prior art system requires removal of one and one non-target containers 106 from the stack 107 before the target container 106′ becomes accessible for the container handling vehicle 200,300,400. The ‘single container digging’ may also reduce the storage system's efficiency of handling containers 106.

It is an aim of the present invention to provide a dedicated container handling and transport vehicle, an automated storage and retrieval system and a method for operating such a system that solves or at least mitigates one or both of the aforementioned problems.

In at least one embodiment of the present invention, it is an aim to provide an automated storage and retrieval system and a method that allows effective transport of containers between storage spaces having different gas and/temperature zones.

### SUMMARY OF THE INVENTION

The present invention is set forth and characterized in the independent claims, while the dependent claims describe other preferred/optional features.

In a first aspect, the invention concerns a container transport vehicle for handling and transport of storage containers, wherein the container transport vehicle comprises one or more drive modules, a container carrier and a container handler.

The drive module is configured to move the container transport vehicle along a rail system which comprises a first set of parallel rails arranged in a first direction X and a second set of parallel rails arranged in a second direction Y orthogonal to the first direction X. The intersections of the rails form a grid of grid cells defining grid openings.

In an exemplary configuration two or three of such drive modules are applied to move the container transport vehicle in the first and second directions wherein the container carrier is arranged on/above the drive module and configured to support the storage containers during transport. In case of an elongated container carrier two drive modules may be positioned below each longitudinal end sections of the container carrier. Further, a third drive module may be placed at or around a longitudinal center of the container carrier. Each drive module may be configured to operate independently.

The container handler is arranged at one end of the container transport vehicle in the first direction X that comprises a lifting device configured to raise at least one of the storage containers from a position below the rail system during operation and to lower the at least one of the storage containers onto the container carrier. The container handler is further configured to be displaceable/retractable in the first direction X.

In case of two or more drive modules, the drive modules may be linked to each other by receiving synchronized commands from a remote control system, both in form of horizontal movements along the rail system and in form of change of directions between the first and the second directions X, Y. The latter may for example be achieved by simultaneous lifting/lowering of drive means such as wheels.

Alternatively, or in addition, the drive modules may operate on a master-slave type arrangement, where one or more drive modules mirror the operations of a master drive module.

The drive modules may be linked by other means than the container carrier, for example by interconnecting rods.

The maximum horizontal cross section the drive module, or each of the drive modules, may cover one grid opening.

If only one drive module is used, it may be advantageous to make a drive module covering more than on grid opening to achieve sufficient stability. Alternatively, or in addition, balancing weights may be added to the container transport vehicle.

In an exemplary configuration the container transport vehicle may comprise a displacement mechanism for the container handler, configured to displace the container handler in the first direction (X) along the rail system between a position outside a periphery of the container carrier and a position within the periphery of the container carrier by use of a displacement motor. The first direction X may advantageously be the direction corresponding to the narrower width direction of the storage container since that would allow a larger collection of storage containers to be stored in the container carrier for a given size.

The distribution of the storage containers in the container carrier along the first direction X may be with a double track rail space between them (see accompanying drawings) or less.

In an exemplary configuration the container carrier may comprise a protrusion/ledge/extension at an end of the container transport vehicle opposite the end with the container handler, wherein the protrusion protrudes from the drive module in the first direction X, or if two or more drive modules are used, from the outermost drive module situated closest to the protrusion.

The cross section area of the protrusion relative to the rail system is preferably equal or larger than the cross sectional area of a storage container to be supported on the container carrier, more preferably equal in order to reduce the risk of interference with movements of other vehicles on adjacent cells on the rail system. In case of a protrusion larger than the container's cross-sectional area, the additional area will be in the first direction X.

In an exemplary configuration the container transport vehicle may comprise a vehicle housing covering at least a part of the container carrier. Such a vehicle housing may cover a cross sectional area of the container carrier not including the protrusion.

In an exemplary configuration the displacement mechanism may comprises one or more suspensions mounted on either the container handler or the vehicle housing and one or more tracks or rails forming part of, or mounted on, the other of the container handler or the vehicle housing. The suspension(s) and the track(s)/rail(s) are interconnected to allow movement of the container handle relative to the vehicle housing in the first direction X. For example, a top-side of the container handler may be equipped with rails/suspensions and an inside ceiling of the housing section may be equipped with corresponding tracks, or vice versa.

In an exemplary configuration the vehicle housing may comprise a cover comprising a roof and a cover framework connecting the cover to the container carrier such that a distance between the container carrier and the ceiling of the roof is equal or higher than a maximum height of the storage containers to be transported. The roof may cover the part of the cover framework not including the protrusion.

In an exemplary configuration the container handler may comprise a container handler body comprising a top section and a lower section. A part of the above mentioned displacement mechanism of the container handler is fixed to, or constitutes an integral part of, the top section. Further, the lifting device may be connected to the lower part. The terms ‘top’ and ‘lower’ refer both to the underlying rail system.

In an exemplary configuration the container carrier may comprise a carrier framework and a container displacement mechanism configured to displace the storage containers along the carrier framework while supported on, or attached to, the container carrier. The carrier framework is probably elongated with a longitudinal axis in the first direction X. The container displacement mechanism may be a belt conveyor system and/or a linear activator system.

The maximum displacement distance for which the mechanism may transport the storage containers is preferably more than 90% of the length of the carrier framework.

In an exemplary configuration the container displacement mechanism may comprise a drive shaft, a drive motor rotationally connected to the drive shaft and a belt extending a distance along the container framework corresponding to the maximum displacement distance of the storage containers. The storage containers may be supported directly or indirectly on the belt during transport by the container transport vehicle.

In an exemplary configuration the drive module may comprise a drive module body, a first set of drive means arranged on opposite sides of the drive module body for moving the drive module along the first direction X on the rail system and a second set of drive means arranged on opposite sides of the drive module body for moving the drive module along the second direction Y on the rail system. The drive module body may also comprise a drive means motor for driving the drive means and a power source configured to provide propulsion power to the drive mean motor.

In a second aspect, the invention concerns a container transport vehicle for handling of and transport of a multiple number of storage containers, wherein the container transport vehicle comprises one or more drive module configured to move the container transport vehicle along a rail system, a container carrier arranged on the drive module(s) and configured to support the storage containers (directly or indirectly) during transport.

The container carrier preferably has an elongate design and comprises a carrier body.

The container carrier may also comprise container displacement mechanism configured to displace the storage containers a displacement distance along the carrier body, e.g. while supported onto the container carrier. As for the first aspect, the container displacement mechanism may for example be a belt conveyor system and/or a linear activator system. The displacement distance is preferably more than 90% of the length of the framework.

The rail system may comprise a first set of parallel rails arranged in a first direction X and a second set of parallel rails arranged in a second direction Y orthogonal to the first direction X, the intersections of which rails form a grid of grid cells defining grid openings.

In an exemplary configuration of the second aspect, the container transport vehicle comprises a container handler and a displacement mechanism as described in the first aspect. The container handler comprises a lifting device configured to raise at least one of the storage containers from a position below the rail system during operation and to lower the at least one of the storage containers onto the container carrier.

The configuration of the second aspect container transport vehicle may for the rest be equal or similar to the container transport vehicle of the first aspect.

In a third aspect, the invention concerns an automated storage and retrieval system comprising a container transport vehicle as described for the first or the second aspect which is supported by the above-mentioned rail system.

The automated storage and retrieval system may further comprise a storage volume to store storage containers in vertical stacks, wherein the rail system is arranged above the storage volume.

Further, the container transport vehicle is configured to lift a storage container through a grid opening by use of the lifting device, wherein the grid opening is formed by intersections of the parallel rails of the rail system.

The rail system may at least partly be made of double track rails to ensure better traffic efficiency between the container transport vehicles and any other types of vehicles operating on the rail system.

In an exemplary configuration of the third aspect, the automated storage and retrieval system may comprise one or more container handling vehicles 200,300,400 as described in section ‘background and prior art’.

In an exemplary configuration of the third aspect, the automated storage and retrieval system may comprise a wall separating a first space containing a first part of the rail system from a second space containing a second part of the rail system. The wall comprises an opening having a size and a position allowing the storage containers to pass through the wall when displaced in direction along the container carrier.

In an exemplary configuration of the third aspect, the container carrier may comprise a protrusion/ledge/extension at an end of the container transport vehicle opposite the end with the container handler. The protrusion protrudes from the drive module (or the outermost drive module distal from the container handler in case of multiple numbers of drive modules) in the first direction X with a cross sectional area equal or larger than the cross-sectional area of a single storage container contacting (directly or indirectly) the container carrier during operation.

The opening of the wall may be of any form (rectangular, oval etc.). but shall have a size and a position that allows the protrusion with at least one of the storage containers supported thereon to pass through.

In an exemplary configuration of the third aspect, the wall may comprise a door system which comprises a door covering the opening and a door mechanism configured to open and close the door.

In an exemplary configuration of the third aspect, the door mechanism (72,73) comprises a door shaft and a door motor rotational connected to the door shaft. The door mechanism is coupled to the door such that the door is lifted or lowered when the door shaft is rotated by the door motor.

In a third aspect, the invention concerns a method for handling and transporting a multiple number of storage containers using an automated storage and retrieval system as described for the third aspect of the invention.

The method comprises the following steps:
moving the container transport vehicle horizontally along the rail system such that the lifting device of the container handler is positioned above a grid opening;
lowering the lifting device vertically to a position above a storage container constituting a topmost storage container of a stack;
gripping the storage container;
raising the lifting device vertically such that the storage container is in alignment with, or higher than, the container carrier;
displacing the container handler/the lifting device with the storage container in the first direction X by use of the displacement mechanism until the storage container is in position within the periphery of the container carrier and to a position which are not already occupied by another storage container.

In an exemplary process of the fourth aspect, the method may also comprise the following steps:
lowering the lifting device vertically until the storage container is contacting, or near contacting, the container carrier and
releasing the storage container from the lifting device.

In an exemplary process of the fourth aspect, the container carrier comprises a carrier framework and a container displacement mechanism configured to displace the storage containers along the carrier framework while supported on the container carrier.

Further, the method may comprise the following step:
displacing the storage containers in the first direction X along the container carrier towards an end of the container transport vehicle opposite the end with the container handler.

In an exemplary process of the fourth aspect, the container carrier may comprise a protrusion/ledge at an end of the container transport vehicle opposite the end with the container handler. The protrusion/ledge protrudes from the drive module (or the outermost drive module distal from the container handler in case of multiple numbers of drive modules) in the first direction X with a cross sectional area equal or larger than a cross sectional area of a single storage container contacting (directly or indirectly) the container carrier during operation.

The method may comprise the following step:
displacing the storage containers supported by the container carrier until at least one of the storage containers is arranged into the protrusion.

In an exemplary process of the fourth aspect, wherein the automated storage and retrieval system may comprise a wall separating a first space containing a first part of the rail system from a second space containing a second part of the rail system. The wall may comprise an opening having a size and a position allowing the storage containers to pass through the wall.

In an exemplary process of the fourth aspect, wherein the automated storage and retrieval system may comprise an access station comprising an external displacement mechanism configured to displace storage containers away from the rail system. The displacement mechanism may deliver one or more of the storage containers carried by the vehicle to the external displacement mechanism when its protrusion is positioned next to the external displacement mechanism.

The method may comprise the following step:
moving the container transport vehicle horizontally along the rail system such that an end of the container transport vehicle opposite the end with the container handler is adjacent or within the opening.

In an exemplary process of the fourth aspect, wherein the automated storage and retrieval system comprises the above-mentioned wall with opening, a first container transport vehicle arranged within the first space and a second container transport vehicle arranged within the second space.

The method may comprise the following steps:
moving the first container transport vehicle along the rail system such that an end of the container transport vehicle opposite the end with the container handler is adjacent or within the opening and
transferring the storage container from the first container transport vehicle to the second container transport vehicle through the opening by use of a container displacement mechanism constituting part of the container carrier of the first container transport vehicle.

The size of the container transport vehicle except the protrusion and with the container handler retracted to a position within the periphery of the container carrier may be n×m grid openings, where n and m are any positive integers.

For example, the container carrier of the container transport vehicle without and with the protrusion may be 3×1 grid openings and 4×1 grid openings, respectively.

If the container transport vehicle is made larger, for example 5×1 grid openings including the protrusion, or 5×2 grid openings, it may be an advantage to use more drive modules increase stability, for example one drive module at each longitudinal end and one in the longitudinal center.

When using a multiple number of drive modules, there might be beneficial to use different instruction protocols for the track shift in order to ensure sufficient coordination.

### BRIEF DESCRIPTION OF THE DRAWINGS

The following drawings depict embodiments of the present invention by way of example only and are appended to facilitate the understanding of the invention.

FIG. 1 is a perspective view of a prior art automated storage and retrieval system comprising a rail system onto which a plurality of remotely operated container handling vehicles are operating and a storage volume for storing stacks of containers.

FIG. 2 is a perspective view of a prior art remotely operating vehicle having a centrally arranged cavity for carrying containers therein.

FIG. 3 is a perspective view of a prior art remotely operating vehicle having a cantilever for carrying containers underneath.

FIG. 4 is a perspective view of a prior art remotely operating vehicle having an internally arranged cavity for carrying containers therein, wherein the cavity is offset from its center relative to the X-direction.

FIG. 5 is a perspective view of an automated storage and retrieval system according to an embodiment of the invention comprising a container transport vehicle.

FIG. 6A-E are perspective views of the automated storage and retrieval system of FIG. 5 illustrating retrieval of a storage container from a storage volume beneath the rail system by the container transport vehicle and arrangement of the storage container into said vehicle.

FIG. 7 shows in perspective a container transport vehicle according to an embodiment of the invention, where FIG. 7A is an exploded view of the vehicle and FIG. 7B shows a section of the vehicle in further detail.

FIG. 8 shows in perspective a container carrier of a container transport vehicle according to an embodiment of the invention, where FIG. 8A shows the container carrier and FIG. 8B shows a section of the container carrier in further detail.

FIG. 9A-D are perspective views of an automated storage and retrieval system according to an embodiment of the invention, illustrating transfer of a storage container between a first container transport vehicle and a second container transport vehicle through an opening of a wall.

FIG. 10 is a perspective view of an automated storage and retrieval system of FIG. 9, where the opening is equipped with a door.

### DETAILED DESCRIPTION OF THE INVENTION

In the following, embodiments of the invention will be discussed in more detail by way of example only and with reference to the appended drawings. It should be understood, however, that the drawings are not intended to limit the invention to the subject-matter depicted in the drawings. Furthermore, even if some of the features are described in relation to the automated storage and retrieval system 1 and the container handling and transport vehicle 10 only, it is apparent that they are valid for the related methods as well, and vice versa.

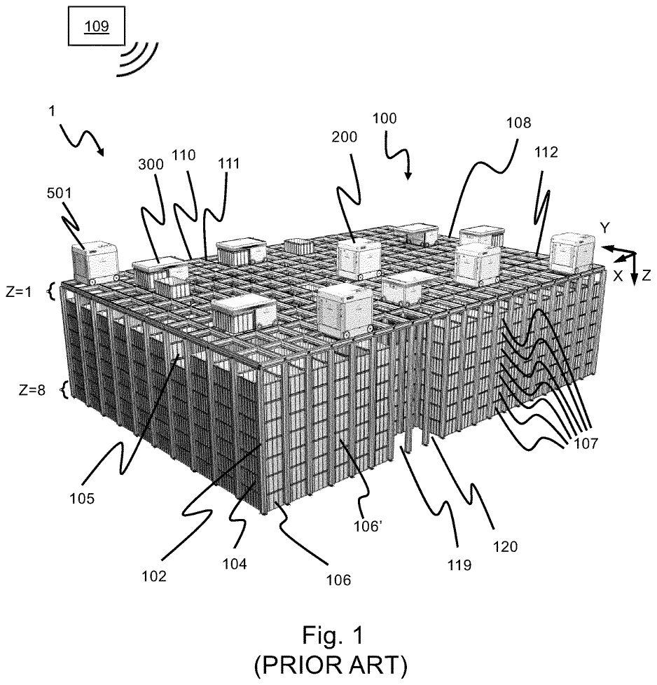

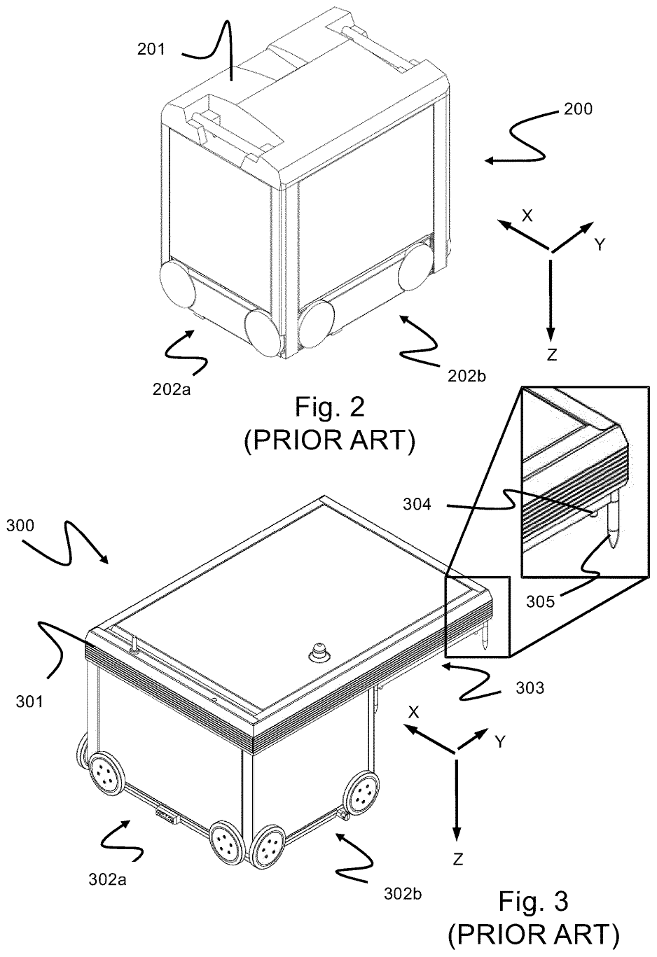

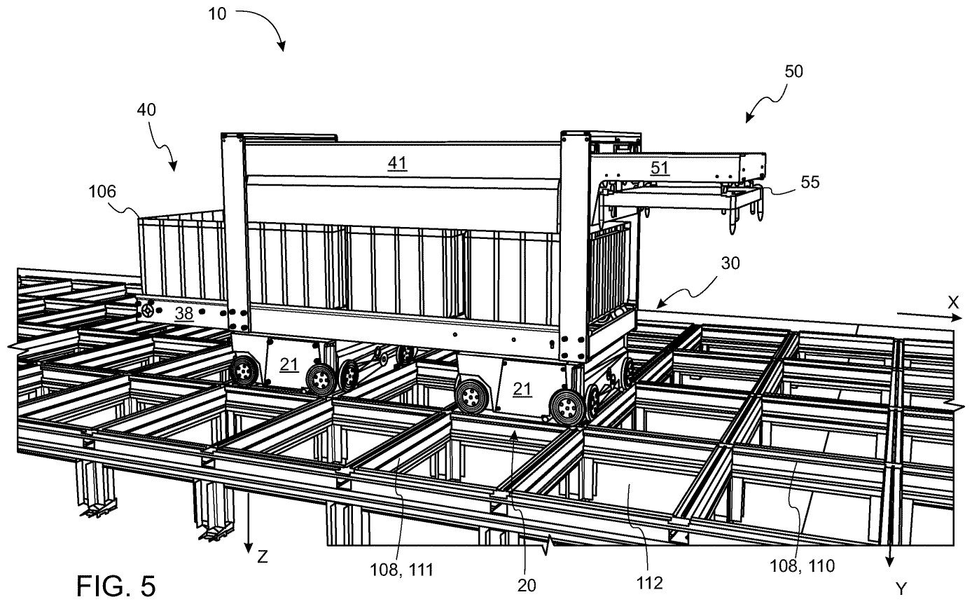

FIG. 5 shows a container handling and transport vehicle 10 according to the invention (hereinafter called ‘vehicle 10’) which operates on a rail system 108 of an automated storage and retrieval system 1 (hereinafter called ‘storage system 1’). The rail system 108 may be similar or identical to the rail system shown in FIG. 1 (see section ‘background and prior art’). X, Y- and Z-directions are indicated in the figure, where the first set of rails 110 are aligned in the X direction and the second set of rails 11 are aligned in the Y-direction.

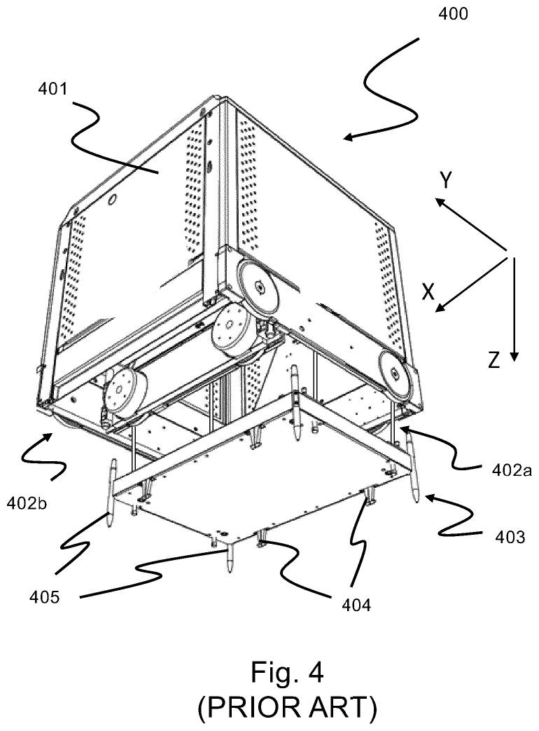

The framework structure 100 of the automated storage and retrieval system 1 may be constructed in a similar or identical manner to the prior art framework structure 100 described above in connection with FIGS. 1-3, that is, a framework structure 100 comprising a number of upright members 102 and storage columns 105 for storing stacks 107 of storage containers 106 arranged in rows between the upright members 102.

The vehicle 10 shown in FIG. 5 comprises
two drive modules 20 enabling the vehicle 10 to drive along the rail system 108 in the X and Y directions,
a container carrier 30 fixed on top of the drive modules 20 and configured to support and displace storage containers 106 in at least one direction,
a vehicle housing 40 covering part of the container carrier 30 and
a container handler 50 allowing handling storage containers 106 arranged in stacks 107 with the storage columns 105.

Each drive module 20 in FIG. 5 has a footprint that covers an area with dimensions in the X and Y directions which is equal or near equal to the lateral extent of a storage column 105/grid opening 112. However, the drive modules 20 may be of any size allowing movements along the rail system 108.

The rails 110,111 are preferably double track rails to enable more efficient/dense traffic on the rail system 108.

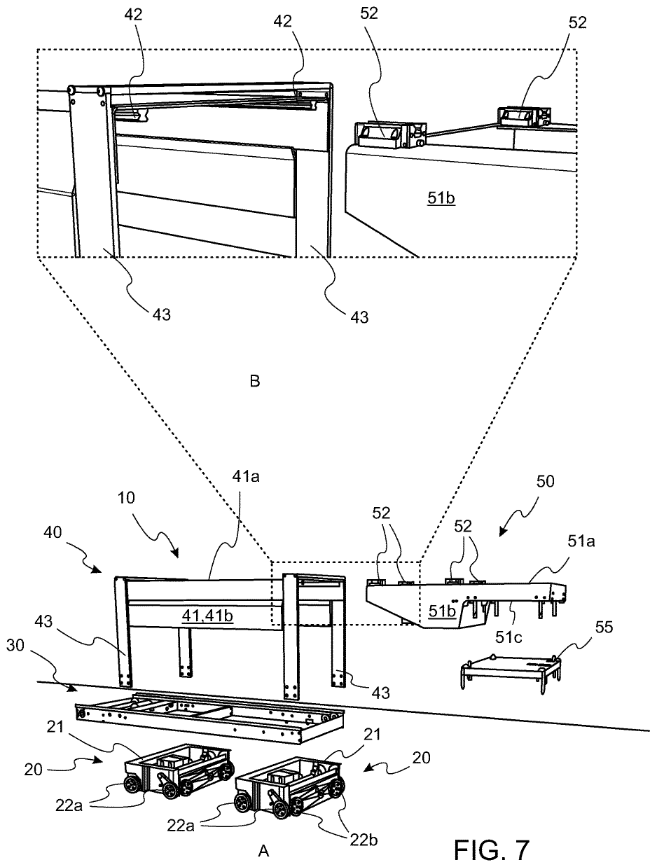

Also with reference to FIG. 7 A, each drive module 20 may comprise first and second sets of wheels 22a,22b which enable movement of the drive module 10 in the X direction and in the Y direction, respectively. The first set of wheels 22a is arranged to engage with two adjacent rails of the first set of rails 110 and the second set of wheels 22b is arranged to engage with two adjacent rails of the second set of rails 111. At least one of the sets of wheels 22a,22b can be lifted and lowered, so that the first set of wheels 22a and/or the second set of wheels 22b can be engaged with the respective set of rails 110, 111 at any one time. Rotational drive force may be provided by drive motor(s) arranged within a drive module body 21 onto which the wheels 22a,22b are fixed and/or in-wheel motors. Alternatively, or in addition, the wheels 22a,22b may be provided with sufficient drive force from one or more motors arranged within the vehicle 10 outside the drive modules 10 and/or from in-wheel motors.

The illustrated container carrier 30 comprises an elongated carrier framework 31 with a longitudinal axis oriented along the X-direction. One of the drive modules 20 is shown arranged below a longitudinal end of the framework 31, while the other is displaced relative to the opposite end with a length in the X-direction corresponding to one grid opening, thereby creating a protrusion/ledge 38.

The vehicle housing 40 includes a cover 41 having a roof/topside 41a and side panels 41b. A cover support 43 in form of two U-shaped frames fixes the cover 41 to the carrier framework 31 such that a tunnel is established which extends in the X-direction along the container carrier 30 except the ledge 38. Note that other designs of the vehicle housing 40 may be envisaged, for example a tunnel covering less than the length of the container carrier 30 minus the ledge 38.

The container handler 50 is displaceable coupled to the vehicle housing 40 and comprises a handler body 51 having a topside 51a and side walls 51b plus a lifting device 55 arranged below at least a part of the handler body 51 such that the lifting device 55 may be lowered and lifted by means of remotely controlled lifting motor(s). Such motor(s) may be arranged within the handler body 51. The lifting device 55 is further configured to allow gripping of storage containers 106 stored in storage columns 105 beneath the rail system 108.

With particular reference to FIG. 7B, said displaceable coupling may be achieved by means of two parallel rails 42 fixed to the inner ceiling of the roof 41a and two suspension knobs/cuboids 52 fixed to the topside of the container handler 50. The guiding knobs 52 and the rails 42 are configured such that the knobs 52 of the container handler 50 may slide/roll along the rails 42 of the vehicle housing 40 when suspended. The length of the sliding/rolling corresponds preferably at least to the length of the container carrier 30 except the ledge 38.

Of course, any coupling between the container handler 50 and the vehicle housing 40 displaceable along the X direction may be envisaged. The inner ceiling of the cover 41 may for example contain tracks into which suspension knobs or suspension rails 52 may slide. A wheeled coupling may also be envisaged.

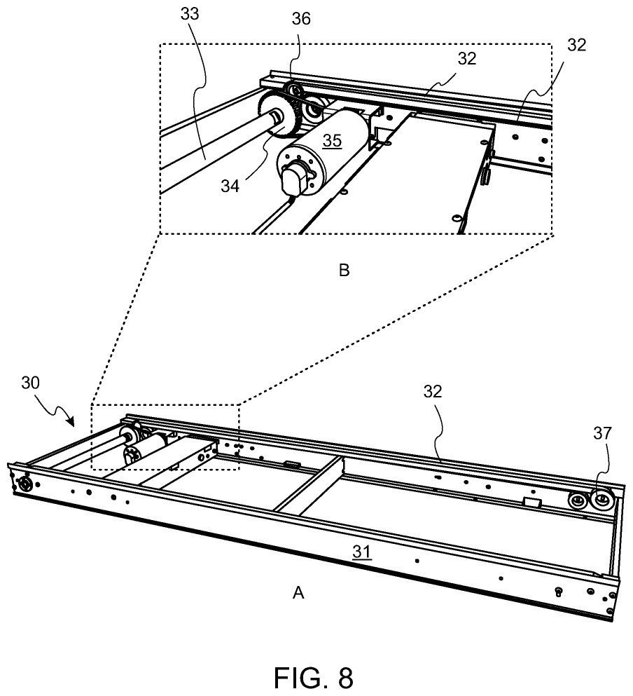

With particular reference to FIGS. 8A and B, the container carrier 31 further comprises a conveyor system 32-37 which may comprise two looped drive belts 32 extending along each sides of the carrier framework 31, a drive shaft 33 arranged at an end of the framework 31 and rotationally coupled to one end of at least one of the looped drive belts 32 via one or more sheaves such as a first pinion gear 34 and a second pinion gear 36, a drive motor 35 rotationally coupled to the sheave/first pinion gear 34 and a sheave 37 arranged at the opposite end of both looped drive belts 32. By operating the drive motor 34 any storage container 106 supported directly or indirectly onto the looped drive belts 32 is consequently displaced along the carrier framework 31 from one end to the other.

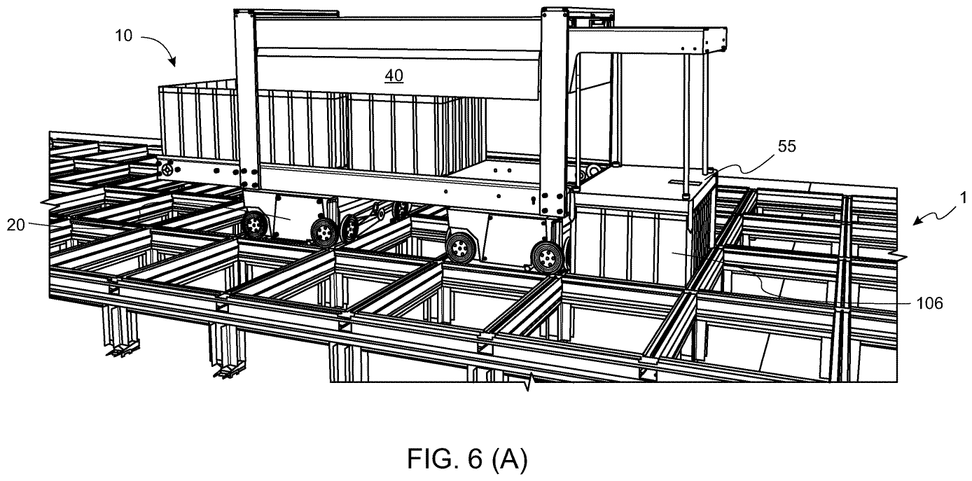

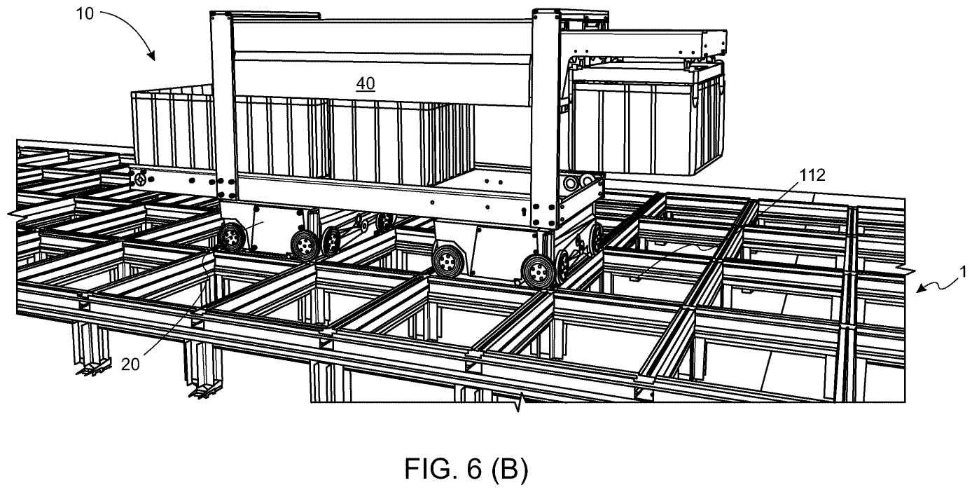

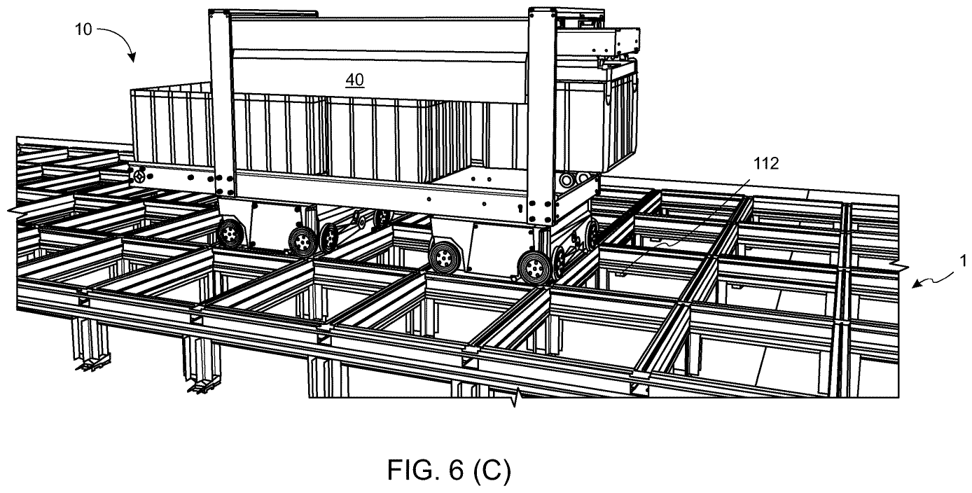

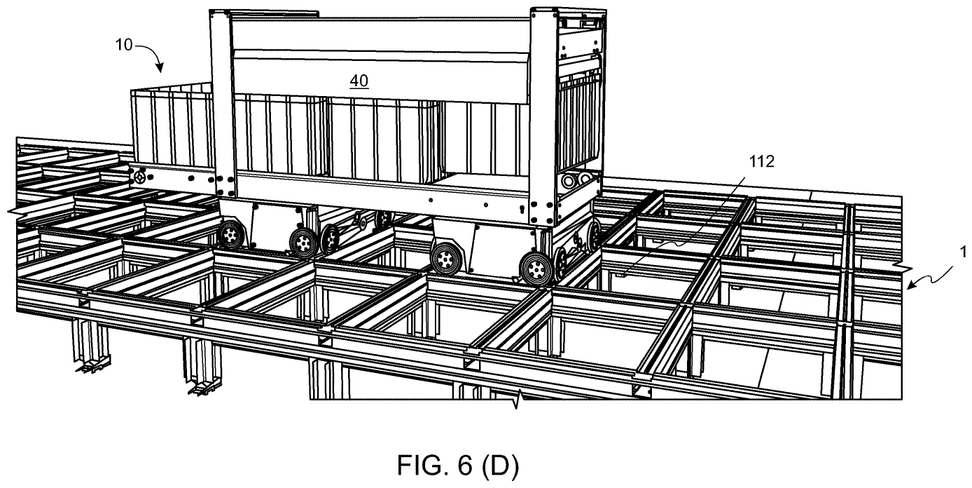

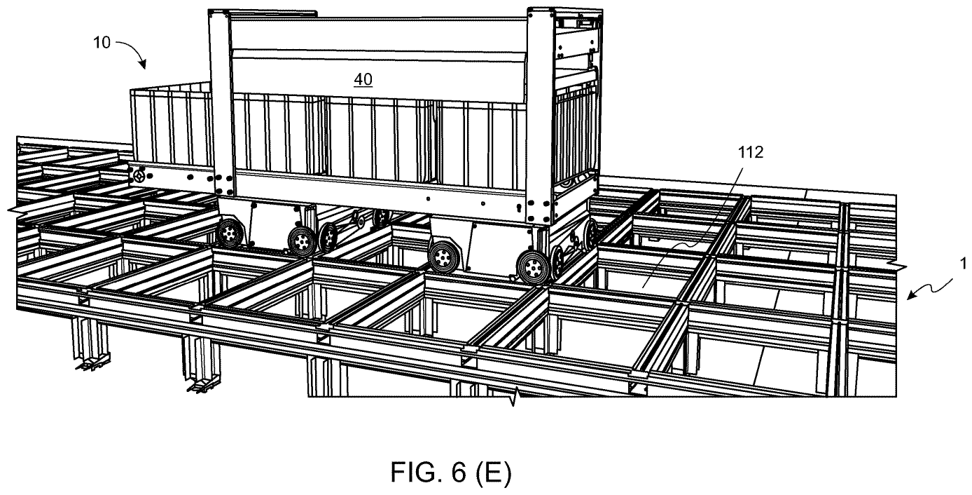

FIG. 6 shows an example of a process to pick up a storage container 106 from a stack 107 within a storage column 106 below the rail system 108:
The container handler 50 is displaced relative to the vehicle housing 40 such that the lifting device 55 is situated fully outside the periphery of the container carrier 30.
(FIG. 6A) The vehicle 10 drives along the rail system 108 by operating the drive modules 20 such that the lifting device 55 is situated directly above a grid opening 112 above a storage column 105 containing one or more target storage containers 106.
(FIG. 6A) The storage container 106 arranged on top of the stack 107 within the storage column 105 is retrieved by lowering the lifting device 55 into the storage column 105 via the grid opening 112, gripping the storage container 106 by operating gripping tools forming part of the lifting device 55 and lifting the lifting device 55 with the storage container 106 through the grid opening 112.
(FIG. 6B) The retrieved storage container 106 is raised until it is positioned aligned with or above the container carrier 30.
(FIG. 6C) The displacement mechanism 42,52 is activated (for example by a remotely operated motor arranged within the handler body 51 and/or within the vehicle housing 40) such that the container handler 50 with the storage container 106 is displaced along the X direction into the vehicle housing 40 and to a position directly above a free area of the container carrier 30, for example the area at the end of the container carrier 30 closest to the grid opening 112.
(FIGS. 6D and 6E) The storage container 106 is lowered onto the free area of the container carrier 30 and released from the lifting device 55.

To allow transport of multiple storage containers 106, the process may be repeated after having displaced the storage container(s) supported by the container carrier 30 in the X direction towards the vehicle's 10 protrusion/ledge 38, thereby freeing an area for arrangement of a new storage container 106. The displacement may be performed as described above, e.g. by use of a conveyor belt 32-37. The new storage container 106 may be retrieved from the same storage column 105 as the preceding storage container(s), or from another storage column 105. The latter alternative involves changing the position of the vehicle 10.

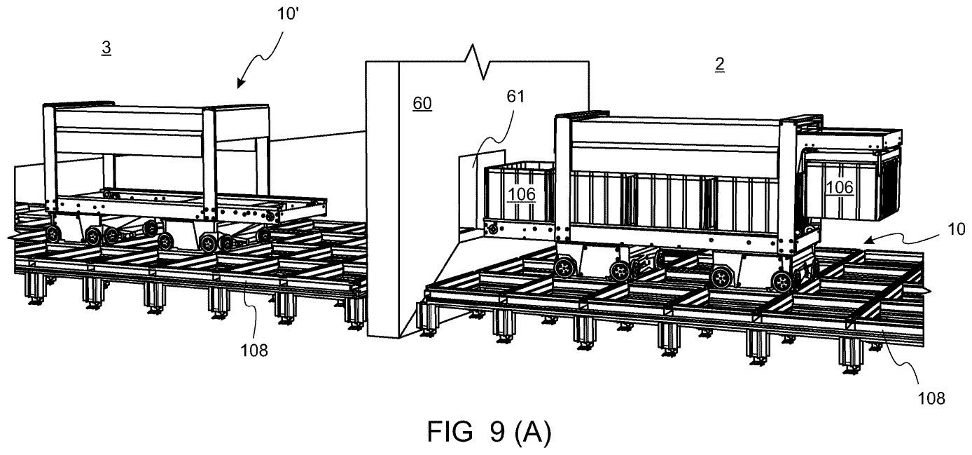

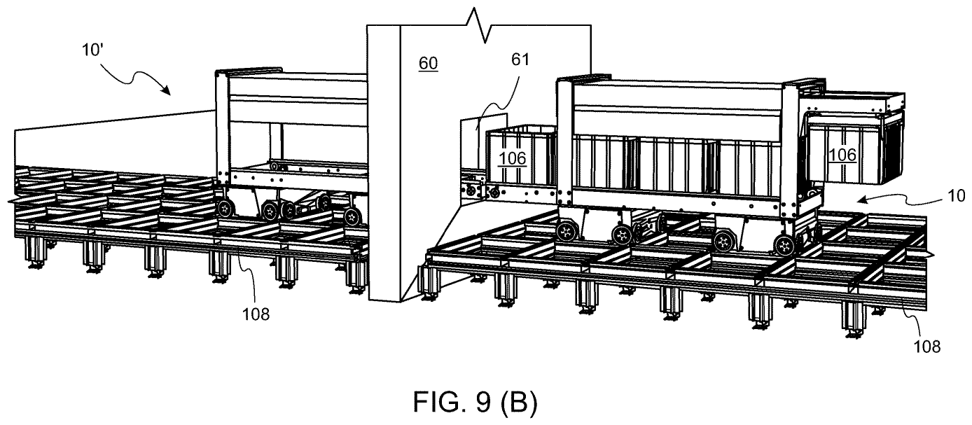

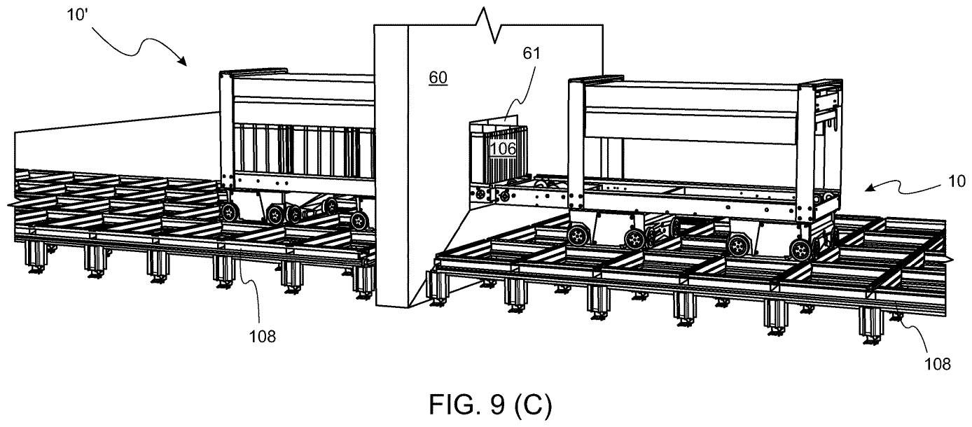

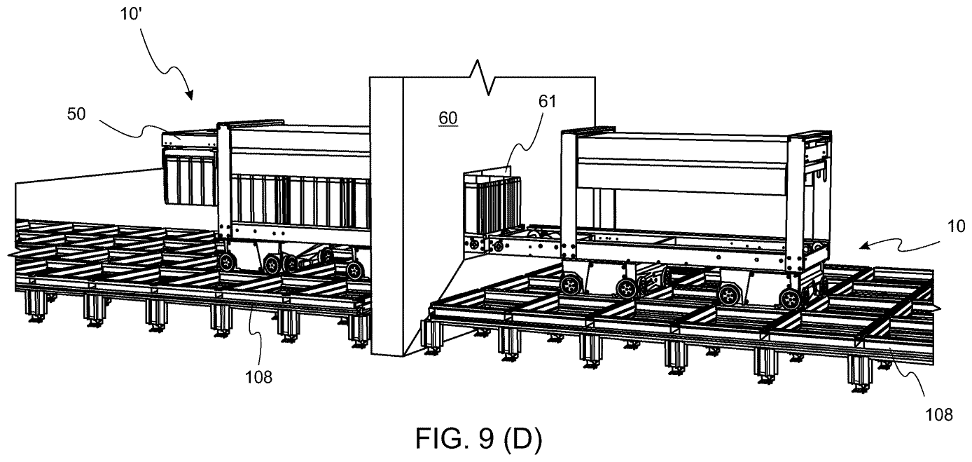

The vehicle 10 in FIGS. 5 and 6 are designed for transporting up to four storage containers 106 (1×4) distributed with a small offset along the entire container carrier 30 (including the ledge 38) and one storage container 106 suspended in the lifting device 55 (see also FIGS. 9A and B), in total five storage containers. However, the vehicle 10 may be made of any size in X direction and Y direction. For example, vehicles may be designed that allow transport of only a single storage container on the container carrier 30 (1×1) and a single storage container suspended from the lifting device 55, in total 2 storage containers. Further, vehicles 10 may be designed with carrier containers 30 allowing support of 1×2 storage containers, 1×3 storage containers, 1×5 storage containers, 2×2 storage containers, 2×3 storage containers, 2×4 storage containers or 3×3 storage containers. In case of vehicles 10 having a container carrier 30 of size equal or wider than two grid openings 112 in the Y direction, two or more adjacent lifting devices may be used, coupled to one or more container handlers 50. The remaining parts of the vehicle 10 may be scaled accordingly. The small offset may e. g. be equal or smaller than the width of a double track rail. No offset may also be envisaged.

FIG. 9A-B show an embodiment of that storage system 1 comprising a wall 60 separating a first space 2 containing a first part of the rail system 108 from a second space 3 containing a second part of the rail system 108. The wall 60 includes an opening 61 having a size and position allowing the ledge 38 of the container carrier 30 with a storage container 106 supported thereon to be inserted when the vehicle 10 is displaced in the X direction.

FIG. 9A shows a first vehicle 10 as described above operating on a rail system 108 within the first space 2, wherein the first vehicle 10 has transported five storage containers 106; four on the container carrier 30 and one suspended below a fully extended container handler 50. The first vehicle 10 has been moved by operating the drive modules 20 to a transfer position where a lower edge of the ledge 38 is positioned adjacent a lower edge of the opening 61. A second vehicle 10 constructed identical to the first vehicle 10 but rotated 180°, is seen approaching the opening 61 from the other side of the wall 60, i.e. along the rail system 108 in the second space 3.

FIG. 9B shows the second vehicle 10 in a transfer position where its ledge 38 has been inserted into the opening 61 and is aligned with and abutting the ledge 38 of the first vehicle 10.

When operating the container displacement mechanism 32-37 of both the first and the second vehicle 10 such that the looped drive belts 32 are both rotating counterclockwise, the storage containers 106 on the container carrier 30 of the first vehicle 10 is displaced onto the container carrier 30 of the second vehicle 10 via the opening 61 and the respective ledges 38.

FIG. 9C shows the result where all the storage containers 106 on the first vehicle 10, including the storage container 106 suspended under the lifting device 55, have been transferred to the second vehicle 10.

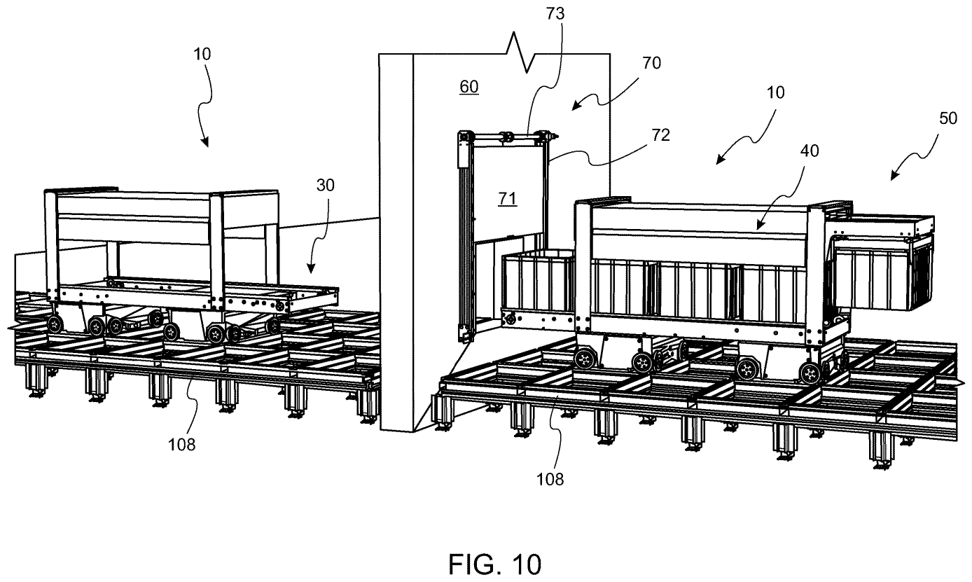

FIG. 10 shows the storage system 1 of FIG. 9 including a door system 70 allowing closing and opening of the opening 61.

The door system 70 includes a door 71, vertical oriented door frames 72 arranged on both sides of the opening 61 into which the door 71 may slide and a door shaft 71 interconnecting the upper ends of the door frames 72. The length of the door frames 72 are shown to be at least the double of the height of the opening 61 and the frames'lower ends are positioned at or near the opening's 61 lower edge. Further, the door shaft 71 may be rotationally coupled to a motor and may be fixed with a wire to the door 71. Hence, by operating the motor the door shaft 71 rotates, causing the door 71 to be lifted or lowered depending on the door shaft's rotational direction, and thereby opening or closing the opening 61.

In the preceding description, various aspects of the container transport vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Automated storage and retrieval system
10 Container handling and transport vehicle/first vehicle
10′ Second vehicle
20 Drive module
21 Drive module body
22a Drive means in first direction (X)/first set of wheels
22b Drive means in second direction (X)/second set of wheels
30 Container carrier
31 Carrier framework
32 Drive belt
33 Drive shaft
34 First pinion gear
35 Drive motor
36 Second pinion gear
37 Sheave
38 Protrusion/ledge
40 Vehicle housing
41 Cover
41a Roof
41b Side panels
42 Housing section/guiding bar/slide bar
43 Cover support
50 Container handler
51 Handler body
51a Topside of handler body
51b Side walls of handler body
51c Lower part of handler body
52 Suspension/hanger/suspension knobs/suspension cuboids
55 Lifting device
60 Wall
61 Wall opening/opening
70 Door system
71 Door
72 Door frame
73 Door shaft
100 Framework structure
102 Upright members of storage volume
103 Horizontal members of storage volume
104 First storage volume
104′ Second storage volume
105 Storage column
106 Container/storage container
106′ Particular position of a container/target container
106″ Vacant storage space for a container
107 Stack
108 Rail system
109 Control system
110 Parallel rails in first direction (X)
111 Parallel rail in second direction (Y)
112 Grid opening
119 First port column/drop-off column
120 Second port column/pick-up column
150 Access station
151 Operator
200 Prior art container handling device/remotely operated vehicle with central cavity
201 Handling device body/Vehicle body
202a Drive means in first direction (X)
202b Drive means in second direction (Y)
300 Prior art container handling vehicle/remotely operated vehicle with cantilever/container handling vehicle
301 Handling device body/Vehicle body
302a Drive means/wheel arrangement, first direction (X)
303b Drive means/wheel arrangement, second direction (Y)
303 Lifting device
304 Gripper element
305 Guiding pin
400 Prior art container handling device/remotely operated vehicle with offset cavity
401 Handling device body/Vehicle body
402a Drive means/wheel arrangement, first direction (X)
402b Drive means/wheel arrangement, second direction (Y)
403 Lifting device
404 Gripper element
405 Guiding pin
X First direction
Y Second direction
Z Third direction

1.-16. (canceled)

17. A container transport vehicle for transport of a multiple number of storage containers, the container transport vehicle comprising:
a drive module configured to move the container transport vehicle along a rail system, which comprises
a first set of parallel rails arranged in a first direction and
a second set of parallel rails arranged in a second direction orthogonal to the first direction;
a container carrier arranged on the drive module, wherein the container carrier is configured to support the storage containers during transport; and
a container handler arranged at one end of the container transport vehicle in the first direction that comprises
a lifting device configured to raise at least one of the storage containers from a position below the rail system during operation and to lower the at least one of the storage containers onto the container carrier;
wherein the container handler is configured to be displaceable in the first direction.

18. The container transport vehicle according to claim 17, wherein the container transport vehicle comprises a displacement mechanism for the container handler, configured to displace the container handler in the first direction between
a position outside a periphery of the container carrier and
a position within the periphery of the container carrier
by use of a displacement motor.

19. The container transport vehicle in accordance with claim 17, wherein the container carrier comprises a protrusion at an end of the container transport vehicle opposite the end with the container handler; and
wherein the protrusion protrudes from the drive module in the first direction.

20. The container transport vehicle in accordance with claim 17, wherein the container transport vehicle comprises a vehicle housing covering at least a part of the container carrier.

21. The container transport vehicle in accordance with claim 20, wherein the displacement mechanism comprises:
a suspension mounted on either the container handler or the vehicle housing; and
a track or rail forming part of, or mounted on, the other of the container handler or the vehicle housing;
wherein the suspension and the track or rail are interconnected to allow movement of the container handler relative to the vehicle housing in the first direction.

22. The container transport vehicle in accordance with claim 17, wherein the container handler comprises:
a container handler body comprising a top section and a lower section;
wherein a part of the displacement mechanism of the container handler is fixed to, or constitutes an integral part of, the top section; and
wherein the lifting device is connected to the lower part.

23. The container transport vehicle in accordance with claim 17, wherein the container carrier comprises:
a carrier framework; and
a container displacement mechanism configured to displace the storage containers along the carrier framework.

24. The container transport vehicle in accordance with claim 17, wherein the container transport vehicle comprises two drive modules onto which the container carrier is arranged.

25. An automated storage and retrieval system comprising:
a storage volume to store storage containers in vertical stacks;
a container transport vehicle in accordance with claim 24; and
the rail system arranged above the storage volume and supporting the container transport vehicle;
wherein the container transport vehicle is configured to lift a storage container through a grid opening by use of the lifting device, the grid opening being formed by intersections of the parallel rails of the rail system.

26. The automated storage and retrieval system in accordance with claim 25, comprising a wall separating a first space containing a first part of the rail system from a second space containing a second part of the rail system;
wherein the wall comprises an opening having a size and a position allowing the storage containers to pass through the wall when displaced in direction along the container carrier.

27. The automated storage and retrieval system in accordance with claim 26, wherein the container carrier comprises a protrusion at an end of the container transport vehicle opposite the end with the container handler, wherein the protrusion protrudes from the drive module in the first direction with a cross sectional area equal or larger than the cross sectional area of a single storage container contacting the container carrier during operation, and wherein the opening of the wall has a size and a position allowing the protrusion with at least one of the storage containers supported thereon to pass through.

28. A method for transporting a multiple number of storage containers, the method comprising:
using an automated storage and retrieval system in accordance with claim 27:
moving the container transport vehicle along the rail system such that the lifting device is positioned above a grid opening;
lowering the lifting device to a position above a storage container constituting a topmost storage container of a stack;
gripping the storage container;
raising the lifting device vertically such that the storage container is in alignment with, or higher than, the container carrier; and
displacing the container handler with the storage container in the first direction until the storage container is in position within the periphery of the container carrier.

29. The method in accordance with claim 28, wherein the method comprises:
lowering the lifting device until the storage container is contacting, or near contacting, the container carrier; and
releasing the storage container from the lifting device.

30. The method in accordance with claim 29, wherein the container carrier comprises a carrier framework and a container displacement mechanism configured to displace the storage containers along the carrier framework while supported on the container carrier;
wherein the method comprises displacing the storage containers in the first direction along the container carrier towards an end of the container transport vehicle opposite the end with the container handler.

31. The method in accordance with claim 30, wherein the container carrier comprises a protrusion at an end of the container transport vehicle opposite the end with the container handler; wherein the protrusion protrudes from the drive module in the first direction with a cross sectional area equal or larger than a cross sectional area of a single storage container contacting the container carrier during operation; and
wherein the method comprises displacing the storage containers supported onto the container carrier until at least one of the storage containers is arranged into the protrusion.

32. The method in accordance with claim 28, wherein the automated storage and retrieval system comprises a wall separating a first space containing a first part of the rail system from a second space containing a second part of the rail system, a first container transport vehicle arranged within the first space and a second container transport vehicle arranged within the second space, wherein the wall comprises an opening having a size and a position allowing the storage containers to pass through; and
wherein the method comprises:
moving the first container transport vehicle along the rail system such that an end of the container transport vehicle opposite the end with the container handler is adjacent or within the opening; and
transferring the storage container from the first container transport vehicle to the second container transport vehicle through the opening by use of a container displacement mechanism constituting part of the container carrier of the first container transport vehicle.
